(19) United States
(12) Patent Application Publication
(10) Pub. No.: US 2024/0125370 A1
(43) Pub. Date: Apr. 18, 2024

(54) BROADBAND LIQUID COLUMN DAMPING SYSTEM AND ADAPTATION METHOD

(71) Applicant: Rheinisch-Westfälische Technische Hochschule (RWTH) Aachen Körperschaft des öffentlichen Rechts, Aachen (DE)

(72) Inventor: Okyay ALTAY, Aachen (DE)

(21) Appl. No.: 18/277,442

(22) PCT Filed: Mar. 25, 2022
(86) PCT No.: PCT/EP2022/057918

§ 371 Date: Aug. 16, 2023

(30) Foreign Application Priority Data
Mar. 29, 2021 (DE) 10 2021 107 849.0

(51) Int. Cl. F16F 7/10; E04H 9/02

(52) U.S. Cl. CPC F16F 7/1034; E04H 9/0235

(57) ABSTRACT

The invention relates to a method and to a liquid column damping system, in particular for damping vibrations, preferably structural vibrations, comprising a tank filled with a liquid, in which at least three preferably vertical columns of the tank, which are spaced apart from one another, in particular for forming communicating liquid columns, are connected by a base region of the tank that is common to all columns, wherein the tank is rotatably mounted about a vertical axis, in particular on a platform that can be rotated about the vertical axis, and, in directions perpendicular to the vertical axis of rotation, has natural frequencies f1, f2, f3, f4 that differ as a function of the direction, wherein the tank can be tuned in terms of the natural frequency f1, f2, f3, f4 thereof acting for a predetermined direction by rotation about the axis of rotation.

The invention relates to a liquid column damping system, which can be used to damp vibrations, for example to damp structural vibrations (such as in buildings and onshore and offshore wind power plants), or to damp vibrations of other objects, comprising a tank filled with a liquid, in which at least three preferably vertical columns, which are spaced apart from one another and are filled with the liquid, in particular partially filled columns of the tank, are connected by a base region of the tank that is common to all columns, in particular whereby liquid columns communicating with the columns are formed.

The invention also relates to a method for frequency tuning such a liquid column damping system.

The shared base region here shall be understood to mean such a region by way of which the lower ends of the columns are connected to one another, in particular in the horizontal direction. Within the meaning of the invention and according to the known prior art, this is the region in which liquid flows from and to each column meet and/or mix with one another. This region thus ensures liquid communication between the columns.

In the prior art, such a liquid column damping system is known, for example, from the publication DE 10 2018 009 356 by the same applicant, in which the columns in each case transition into a shared base region via a horizontal arm. The system, in general terms, is based on the principle of action that the liquid present in the liquid column damping system, such as a Newtonian fluid, is moved during vibrations, whereby energy dissipation takes place.

The basic principle of such a liquid column damping system is also referred to as a Frahm anti-rolling tank, in recognition of the technology attributable to Frahm, the inventor. Such a tank operating according to this basic principle also forms the subject matter of the present invention.

In the aforementioned prior art, the flow in the base region and that in the adjoining horizontal arms of the columns differ in magnitude, depending on the direction of vibration. The magnitude of the flow, relative to the direction of the arms, is proportional to the vectorial splitting of the exciting vibration into the directional components defined by the arm directions. The action is thus generally omnidirectional, but not optimized in every possible direction of vibration. An improvement in the damping is brought about, in contrast, by the usual tuning of the natural frequency in a certain vibration direction using elements that influence the flow and act inside the tank.

It is thus an object of the invention to provide a liquid column damping system which corresponds to the design mentioned at the outset comprising multiple columns, which, however, can be better tuned in terms of damping for a particular direction of vibration. In particular, the natural frequency tuning for a particular direction of vibration is not to be predominantly carried out by way of elements that influence the flow, since in this way the natural frequency can only be tuned to a low degree.

This object is achieved according to the invention by mounting the tank so as to be rotatable about a vertical axis, in particular on a platform that can be rotated about the vertical axis, and by the tank, in directions perpendicular to the vertical axis of rotation, having natural frequencies that differ as a function of the direction, wherein the tank can be tuned in terms of the natural frequency thereof for a predetermined direction by rotation about the axis of rotation. This predetermined direction is in particular the direction in which a structure to be protected by the tank is excited to vibrate.

In the method, the object is achieved by the tank having, in directions perpendicular to a vertical axis of rotation, natural frequencies that differ as a function of the direction, and by the tank being tuned in terms of the at least one natural frequency acting for a predetermined direction by rotation about the axis of rotation.

The invention takes advantage of the property of the tank of being designed so as to already have different discrete natural frequencies as a function of the direction, in particular as viewed in a horizontal plane. As a result of the rotatable mounting of the tank, the option then exists to rotate the tank about the vertical axis, and thereby deliberately bring to bear one or more of the directionally dependent natural frequencies thereof in the required direction of action. In particular, the tank according to the invention can thus be tuned in a broadband manner.

The direction of action is the direction in which the damping is to take place. This usually coincides with the excitation direction. Preferably, the one natural frequency is, or the multiple natural frequencies are, or the tank direction in which this acts or these act is, placed in the required direction of action which is closest to the frequency of the vibration that has occurred so as to achieve maximum energy dissipation.

For example, it may be provided for this purpose that the liquid column damping system comprises at least one vibration sensor, by way of which the vibration direction and/or the vibration frequency of an arrangement comprising the liquid column damping system, in particular of a building, can be detected as a measured variable, and that the liquid column damping system is configured to rotate the tank as a function of at least one of the detected measured variables, and in particular to move the tank, by rotating the same, into a position providing greater damping for the detected vibration compared to the previous position.

In contrast to the prior art, the invention thus provides for, not merely changing the natural frequency that is fixedly present in one direction in the case of a static tank, but deliberately selecting one or more, in particular two, of multiple discrete natural frequencies of the tank for a required direction of action by rotation.

Preferably, natural frequencies that differ as a function of the direction may be generated by liquid volumes in the tank that differ as a function of the direction and can be caused to vibrate. This may be achieved, for example, by cross-sections of the columns and of the regions (arms) connecting these to the base region which differ as a function of the direction and/or by distances, which differ as a function of the direction, of the columns with respect to the shared base region, in particular with respect to the shared axis of rotation, which preferably extends through the base region.

In the invention, a respective column preferably transitions, in particular from the vertical extension direction, at the lower end thereof, into the horizontal direction of a respective arm belonging to the column, for example by way of a tube section that is bent at a right angle. As a result of the arm, the column opens into the shared base region.

Within the arm, a horizontally oriented flow thus exists, namely in the connecting direction between the lower column end and the shared base region, which preferably forms the center or a central region of the damping system, in which all flows converge.

A respective arm may, in the extension thereof, preferably extend rectilinearly between the column and the base region, in particular in the radial direction with respect to a shared point, in particular a shared center in the shared base region, around which the columns are disposed, and preferably about which the entire tank can be rotated. In another embodiment, an arm can also have a non-rectilinear progression, for example a bent progression, for example having a circular segment-shaped bend.

The invention can provide that, with respect to at least some columns, the tank has different natural frequencies in the connecting direction from the column to the axis of rotation. In particular, when another column is not disposed exactly 180 degrees opposite, about the axis of rotation, of each column, it may be provided that, with respect to each column, the tank has a different natural frequency in the connecting direction from the column to the axis of rotation.

In contrast, it is particularly preferably provided that the tank comprises at least two, and preferably at least three, column pairs, wherein the two columns of at least one column pair, and preferably the two columns of each column pair, are spaced 180 degrees apart about a location in the base region of all columns, preferably about the axis of rotation, wherein the arms of the two columns of a column pair preferably have a shared center line extending through the base region, and in particular through the axis of rotation, and, for each column pair, the tank has a different natural frequency in the connecting direction of the two columns. The columns of a column pair are disposed exactly opposite one another about the axis of rotation.

Disposing column pairs in the tank results in a particularly sharp definition of discrete natural frequencies in each case in the connecting direction or separation direction between the two columns of a pair.

The invention can accordingly provide aligning, in a required damping direction, the column pair that is best suited for vibration damping in this direction by rotation of the tank. The best-suited direction of the tank may correspond exactly to a connecting direction of the columns of a selected column pair, but may also be located between the connecting directions of two adjoining column pairs, for example when none of the natural frequencies of a column pair exactly fit the excitation frequency, but the natural frequencies of two column pairs are around the excitation frequency. In this embodiment, it may preferably be provided that the distance between the columns of a column pair, as viewed in the radial direction, differs for at least several column pairs, and preferably for all column pairs. In particular, the inner cross-sections of all columns and arms in this embodiment may be the same, in particular except for a maximum deviation of plus/minus 20%, and preferably of plus/minus 10%. All columns and arms can thus, for example, be formed of bent tube elements. The different natural frequencies of the column pairs are thus at least substantially based on the different distances between the columns in the column pairs.

In particular in this embodiment, the invention can provide that the arms of all the columns open into the shared base region at the same radial distance with respect to the axis of rotation.

The option also exists for the radial distance between the columns of a column pair to be the same in all column pairs, wherein the inner cross-sections of the columns and arms in the column pairs differ for each pair.

This essentially results in a tank configuration having a rotationally symmetrical design, which may be advantageous, depending on the application. In this embodiment, the different natural frequencies in each column pair result from the different cross-sections. The columns and arms of a pair can preferably, in turn, be formed of bent tube elements.

In all embodiments, it may preferably be provided that the columns are uniformly disposed around a point, in particular a center in the base region, preferably about the vertical axis of rotation in the base region, preferably in each case at the same angular distance between the columns or column pairs.

When columns are disposed in pairs, it is furthermore preferred when at least one column pair is disposed at 90 degrees in relation to another column pair in terms of the extension direction of the arms. A tank particularly preferably comprises four column pairs, wherein the arms of adjoining column pairs are disposed at 45 degrees with respect to one another. In this way, each column pair is assigned another column pair, which is oriented perpendicular thereto.

In this way, it can be achieved that a column pair can be rotated, with the extension direction of the arms thereof connecting the columns, into a required direction of action, so that the natural frequency of this column pair comes to bear, wherein, at the same time, another column pair, with the extension direction of the arms thereof, is located perpendicular thereto, and for this reason does not act with respect to the set direction of action.

It may furthermore be provided that the natural frequency in the direction of the spacing of the columns of a column pair can be changed in at least one of the column pairs, preferably in all column pairs, by at least one control element assigned to the respective column pair, in particular a flow-damping control element, preferably a rotatable flap, or by at least one element changing the flow-permitting volume of a column pair.

If no column pairs are used, in contrast, the natural frequency in the direction of the spacing of a column with respect to the axis of rotation can preferably be changed by at least one control element assigned to the column and the arm thereof, in particular a flow-damping control element, preferably a rotatable flap, or by an element changing the flow-permitting volume of the column.

The invention can thus preferably provide that a damping element that is adjustable, in particular adjustable by way of an actuator, is disposed in each arm of a respective column, or each pair of arms of a column pair which are located 180 degrees opposite one another, and can be used to adjust the free flow cross-section in the arm. Such a damping element can, for example, be a flap that can be pivoted about an axis.

A damping element can, generally speaking, be designed as a valve actuator, by way of which the free flow cross-section of an arm can be varied between a maximum and a minimum. It is also possible, for example, for a sliding valve or ball valve system to be used. In this way, it is possible to individually adjust the natural frequency, and thus the damping, for each column, or each column pair, in particular without influencing the natural frequency of another column or another column pair.

In addition to an initial selection of the natural frequency by rotation of the tank, it is thus possible to carry out a fine adjustment of the natural frequency in the direction selected as a result of the rotation.

The invention can provide for metrologically detecting vibration directions and/or vibration frequencies, for example of a structure (for example a building) in which such a system is used, using at least one sensor and, as a function of the detected vibration direction/frequency, influencing not only the rotational position of the tank, but also automatically changing the damping in the individual arms or column pairs, in particular so that the damping is optimized for the detected direction.

For this purpose, an open-loop control unit and/or closed-loop control unit may be provided, which generates activation signals from the detected vibration data, by way of which actuators are activated, which bring about the rotation of the tank and/or adjust the damping elements in the arms.

The invention can furthermore also provide that each column, in the vertical direction, in particular in the rinsing region of the liquid, and preferably across the entire column length, is divided into multiple chambers, which are situated parallel next to one another in the vertical direction, with at least a partial number of all the chambers, and possibly all the chambers, comprising a valve element, in particular a valve element adjustable by way of an actuator, by way of which the flow of liquid into and out of the respective chamber can be limited and/or blocked.

By selectively unblocking or blocking one or more chambers, the effective cross-section of each column can be varied and, as a result, the natural frequency of the system, in particular that of a column pair, can be influenced as a function of the direction in the connecting direction of the two columns. The chambers of each column preferably have at least partially different cross-sections, in particular so that a plurality of different cross-sections of the respective column can be set by varying the unblocked and blocked chambers.

The invention can provide that the aforementioned valve element of a respective chamber is disposed at the upper end of the chamber, and that the free cross-section of the chamber with respect to the surrounding atmosphere can be varied, and in particular blocked, by way of the valve element. In this way, it is possible to establish whether or not the respective chamber is part of the communicating volume of the respective column. Each valve element can preferably be switched, by way of an actuator, at least between the maximally closed position, preferably a blocking position, and the maximally open position, and in particular it is also possible to set intermediate positions.

As a result of the preferred division of the column cross-section into chambers, the invention moreover achieves stabilization in the movement of liquid in the columns in that the division of the liquid surface into smaller regions prevents possible wave formation.

The invention can provide that the actuators of the valve elements are activated by an open-loop/closed-loop control unit, in particular the same as the aforementioned open-loop/closed-loop control unit, as a function of a metrologically detected vibration of the structure in which the system is used, in particular so as to set the natural frequency as a function of the detected frequency of the vibration, in particular following a preceding rotation of the tank.

The invention can also provide that a fill level sensor is disposed at, at least, one column, and in particular at each column, by way of which the current fill level of the liquid in the column and/or the movement of liquid in the column, in particular in a chamber that cannot be closed with respect to the surrounding atmosphere, can preferably be dynamically measured. The damping in each arm and/or the effectively active column cross-sections can likewise be changed as a function of the ascertained fill levels of each column.

This results in active variability of the system parameters of a liquid column damping system according to the invention, in particular of the natural frequency and of the damping as a function of the detected vibration data, preferably the direction and the frequency of the vibration. The system can thus also respond in-situ to a metrologically detected vibration, for example due to earthquakes and wind and wave loads, and preferably optimize the system parameters as a function of the direction, in particular at least the rotational position of the tank, and preferably finely adjust the natural frequency of the tank in the required direction of action.

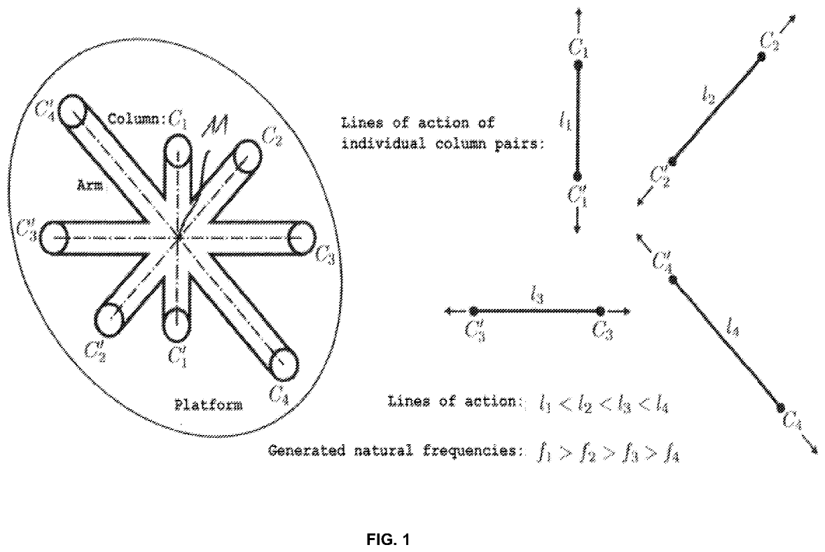

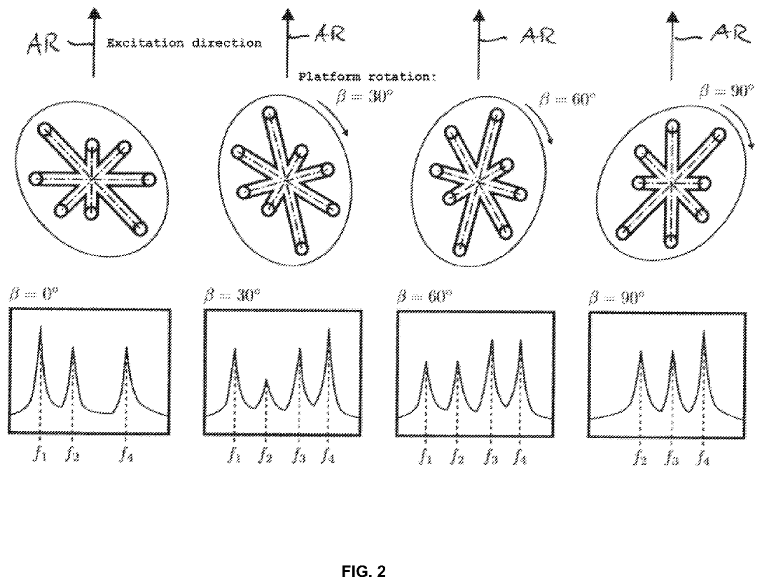

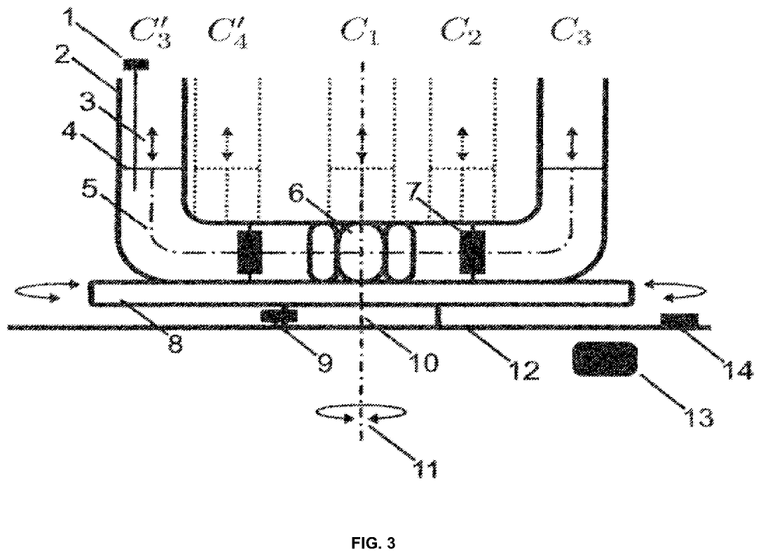

An exemplary embodiment of the invention will be described based on the following figures. FIGS. 1 and 2 show the system in a top view, and FIG. 3 shows this in a side sectional view.

FIGS. 1 and 2 show an embodiment of the invention having a particularly preferred design. The tank of the liquid column damping system comprises four column pairs here, namely a first column pair C1, C1′, a second column pair C2, C2′, a third column pair C3, C3′, and a fourth column pair C4, C4′. The respective columns preferably extend vertically and are open toward the top. Such a vertical orientation of the columns, however, is not absolutely necessary for the invention. At the lower end, each column, in each case, transitions with respect to the vertical axis of rotation 11 into a radially extending arm. The arms of the columns of a column pair extend in the same radial direction, and in particular the center lines thereof are collinear. The respective arm connects the respective column to the shared base region 6, which is embodied around the axis of rotation 11. The center lines of all arms intersect the vertical axis of rotation 11.

A valve element, here in the form of a respective rotatable cover/flap 7, can be disposed at each of the arms, by way of which the free flow cross-section in the respective arm can be changed. These valve elements 7 can be disposed close to the base region 6, but are situated within the arms. The flaps are only visualized in FIG. 3.

In this embodiment, an angle of 45 degrees is included in each case between the adjoining arms. The column pair C1, C1′ is thus oriented, in the direction of separation of the columns thereof, perpendicular to the column pair C3, C3′, and the column pair C2, C2′ is oriented perpendicular to the column pair C4, C4′. The two arms of a column pair preferably both have the same length. In contrast, the distance between the columns of a column pair is different in all column pairs. Apart from the locations of the valve elements 7, the flow cross-sections are the same in all columns and arms.

As a result, the tank, formed of the columns, the arms, and the base regions, has natural frequencies in the possible horizontal directions, which differ as a function of the direction, here specifically a different natural frequency in the direction of separation of the columns for each column pair. This natural frequency of a respective column pair can be changed by the valve elements.

In the region on the right in the illustration, FIG. 1 shows that the tank has four different directions of action along the separation direction of the two columns of each column pair. In each direction of action, a different natural frequency is present. Since the lengths of the column pairs increase, or the distance between the columns thereof increases, from pair C1, C1′ to pair C4, C4′, it follows for the natural frequencies that f1>f2>f3>f4, wherein the highest frequency is assigned to the shortest direction of action, or the shortest distance between the columns.

FIG. 2 shows the frequency conditions with respect to the same excitation direction AR of a vibration, for example in a building in which the damping system is used.

FIG. 2 shows four different rotational positions of the tank. In the first and last rotational positions, in each case one column pair is oriented in the excitation direction, and another is oriented perpendicularly thereto. The frequency contribution in the effective frequency spectrum of the tank is thus missing in these rotational positions for the column pair which is oriented perpendicularly to the excitation direction AR with respect to the direction of separation of the columns. As a result, the frequency f3 is missing in the first rotational position, and the frequency f1 is missing in the last rotational position. The natural frequency of the column pair which is oriented in the excitation direction with respect to the direction of separation of the columns thereof has the highest contribution in the frequency spectrum, and thus experiences the greatest damping.

In the second and third rotational positions, the tank is in a position in which the excitation direction is located between two adjoining column pairs. Even though all frequencies are present in the spectrum of action of the tank, these are present with different damping magnitudes, depending on the rotational position.

It is apparent from FIGS. 1 and 2 that, for a certain vibration, for example of a building including this system, by rotating the tank, one or more of the directionally dependent natural frequencies can be brought to bear in the excitation direction of the vibration, and the vibration can thus be effectively damped.

FIG. 3 shows the essential components of the system in a side sectional view. The tank, including the columns 2 thereof of the column pair C, is completely disposed on a rotatable platform 8 here and can thereby be rotated about the vertical axis of rotation 11 in different orientations. The platform 8 is disposed at the bottom 12 of an arbitrary structure, for example a building or a wind power plant or the like, by way of the rotating support 10. It may also be provided that the platform is rotatably supported, radially outward of the driven rotating support 10, for example in a region between the column 2 located most radially inward and the one located most radially outward, for example by way of a circular rail system on which the platform 8 is supported. However, this is not shown.

The rotation about the axis 11 can be carried out using a drive 9 at the rotating support.

Fill level sensors 1, in particular one in each case per column pair C, can be used to dynamically measure the liquid level in a column 2 of each pair C. The static liquid level 4 is visualized in the tank, as is the deflection direction 3 of the liquid in the columns 2.

To detect the vibrations, at least one vibration sensor 14 can be provided at the structure to be damped, for example an acceleration sensor or a speed sensor. In particular, the excitation direction of the vibration and/or the frequency thereof can be measured by way of one or more such sensors 14.

The measured values of the sensor or sensors 14 can be evaluated by way of a control unit 13, and at least the drive of the rotating support 10 can be activated to adjust the tank in a desired direction. Likewise, activation of the valve elements 7 for fine-tuning the natural frequency of the tank in the excitation direction can be carried out by the control unit 13.

This tuning of the natural frequency in the required direction of action of the tank, which corresponds to the excitation direction of the vibration, can take place in-situ when an event occurs, for example in the case of earthquakes and wind and wave loads.

1. A liquid column damping system for damping structural vibrations, comprising a tank filled with a liquid in which at least three vertical columns of the tank, which are spaced apart from one another and configured to form communicating liquid columns, are connected by a base region of the tank that is common to all the columns, wherein the tank is mounted on a platform which is rotatable about a vertical axis, and, in directions perpendicular to the vertical axis of rotation, has natural frequencies f1, f2, f3, f4 that differ as a function of direction, the tank being tunable in the natural frequency f1, f2, f3, f4 thereof acting for a predetermined direction, by rotation about the axis of rotation.

2. The liquid column damping system according to claim 1, wherein the natural frequencies f1, f2, f3, f4 that differ as a function of the direction are generated by liquid volumes that differ as a function of the direction and can be caused to vibrate and which comprise cross-sections of the columns that differ as a function of the direction and/or by distances that differ as a function of the direction and which distances comprise distances of the columns with respect to the axis of rotation.

3. The liquid column damping system according to claim 1, each of the columns transitions at a lower end thereof into a respective horizontally extending arm which opens into the base region.

4. The liquid column damping system according to claim 3, wherein each of the horizontally extending arms is configured to extend between the lower end of the column from which the arm horizontally extends and the base region in a radial direction with respect to a center in the shared base region coincident with the axis of rotation.

5. The liquid column damping system according to claim 4, wherein the columns comprise at least three column pairs the two columns of each of the column pairs being spaced 180 degrees apart about the axis of rotation, the arms of the two columns of each of the a column pairs having a common center line extending through the axis of rotation and the tank, in each of the column pairs, having a different natural frequency f1, f2, f3, f4 in a direction connecting the two columns of the column pair.

6. The liquid column damping system according to claim 5, wherein a distance between the columns of each of the column pairs is different from the others, inner cross-sections of all the columns and arms being the same except for a maximum deviation of plus/minus 20%.

7. The liquid column damping system according to claim 6, wherein all of the arms open into the base region at a same radial distance from the axis of rotation.

8. The liquid column damping system according to claim 5, wherein a radial distance between the columns of each of the column pairs is the same as the others, inner cross-sections of the columns and arms being different for each pair.

9. The liquid column damping system according to claim 1, wherein the columns are disposed about the axis of rotation at a same angular distance between the columns.

10. The liquid column damping system according to claim 5, further comprising for at least one of the column pairs a respective control element comprising a flow-damping element or element configured to change flow-permitting volume of the column pair whereby the natural frequency f1, f2, f4 in direction of spacing of the columns of the column pair.

11. The liquid column damping system according to claim 4, further comprising for at least one of the columns or horizontally extending arm thereof a respective control element comprising a flow-damping element or element configured to change flow-permitting volume of the column whereby the natural frequency f1, f2, f3, f4 in a direction of spacing of the column from the axis of rotation can be changed.

12. The liquid column damping system according to claim 1 in combination with a building to which the system is operatively connected, further comprising at least one vibration sensor configured to detect a vibration direction and/or a vibration frequency of the liquid column damping system as a measured variable, and wherein the liquid column damping system is configured to rotate the tank, as a function of at least one detected measured variable including the vibration direction and/or the vibration frequency, into a position providing greater damping for the detected vibration compared to a rotational position of the tank before the rotation thereon.

13. A method for frequency-tuning a liquid column damping system to damp structural vibrations, comprising operatively connecting a tank filled with a liquid in which at least three vertical columns of the tank, which are spaced apart from one another and configured to form communicating liquid columns, are connected by a base region of the tank that is common to all the columns, wherein the tank, in directions perpendicular to a vertical axis of rotation of the tank, has natural frequencies f1, 12, f3, f4 that differ as a function of the direction, and tuning the tank in the natural frequency f1, f2, f3, f4 thereof acting for a predetermined direction, by rotating the tank about the axis of rotation.

14. The liquid column damping system according to claim 6, wherein the maximum deviation is plus/minus 10%.

15. The liquid column damping system according to claim 10, wherein the control element comprises a rotatable flap.

16. The quid column damping system according to claim 11, wherein the control element comprises a rotatable flap.
